(19) United States
(12) Patent Application Publication
(10) Pub. No.: US 2019/0116214 A1
(43) Pub. Date: Apr. 18, 2019

(54) METHOD AND SYSTEM FOR TAKING PICTURES ON REAL TIME DYNAMIC BASIS

(71) Applicant: Yagerbomb Media Pvt. Ltd., Mumbai (IN)

(72) Inventors: Prateek LAL, Vadodara (IN); Yuvraj BHALLA, Mumbai (IN); Sumit KUMAR, Bhagalpur (IN)

(21) Appl. No.: 15/980,331

(22) Filed: May 15, 2018

(30) Foreign Application Priority Data
Oct. 18, 2017 (IN) 201721037038

(51) Int. Cl. H04L 29/06; G06T 7/33; G06F 21/73

(52) U.S. Cl. CPC H04L 65/602; G06Q 50/01; G06F 21/73; G06T 7/337

(57) ABSTRACT

The present disclosure provides a method and system for taking a real-time single image of at least two users located at different geographical locations. The system executes instructions to causes one or more processors to perform a method. The method includes creation of channel to facilitate a connection and generates a unique code on the first portable communication device. The method includes reception of a first set of data associated with the first portable communication device, triggers a camera and collects a second set of data associated with a preview image of a first user. The method includes reception of a first set of data associated with a second portable communication device, triggers a camera and collects a second set of data associated with the image of a second user. The method includes a step to take the single image based on the user input.

### TECHNICAL FIELD

The present disclosure relates to a field of photography and videography. More specifically, the present disclosure relates to a method and system for taking a single image of at least two users located at different geographical locations on real-time dynamic basis.

### BACKGROUND

With the advancements in technology over the last few years, a large number of portable communication devices have surfaced in the market. One of the portable communication devices which are being used constantly is a smartphone. Nowadays, the users are heavily dependent on their smartphones to perform various tasks such as taking a cab, instant messaging, clicking pictures and the like. These smartphones are equipped with a camera which allows the users to click pictures in real time. With the advent of social media, the users spend a lot of time in clicking pictures on their smartphone for posting on various social media platforms. Typically, two or more users need to be present at a same location or together in order to get a picture clicked. The picture may be taken with a front camera or a back camera in real time. The users may want to get a picture clicked with some other user who is present in a different geographical location. However, the currently available systems are limited to clicking pictures with users present in the same location in front of same camera.

### SUMMARY

In a first example, the present disclosure provides a computer-implemented method for taking a real-time single image of at least two users located at any two different geographical locations. The method may include a first step of creating a channel to facilitate a connection between at least two portable communication devices. In addition, the method may include another step of generating a unique code on the first portable communication device to build the connection with at least the second portable communication device. Further, the method may include yet another step of receiving a first set of data associated with the first portable communication device. Furthermore, the method may include yet another step of triggering a camera associated with the first portable communication device system for rendering a real time preview of an image of the first user. The camera is triggered by a first signal generator circuitry embedded inside the first portable communication device. Moreover, the method may include yet another step of collecting a second set of data associated with body of the first user after performing one or more operations on the preview image of the first user. In addition, the method may include yet another step of receiving a first set of data associated with the second portable communication device after the connection of the at least two portable communication devices. Further, the method may include yet another step of triggering a camera associated with the second portable communication device for rendering a real time preview of an image of the second user. The camera of the second portable communication device is triggered by a second signal generator circuitry embedded inside the at least second portable communication device. Moreover, the method may include yet another step of collecting a second set of data associated with the body of the second user after performing one or more operations on the preview image of the second user. Furthermore, the method may include yet another step of taking the single image of the at least first user and the second user by synchronizing the hardware elements. The hardware elements are associated with the at least two portable communication devices. The first portable communication device is associated with the first user and the second portable communication device is associated with the second user. The channel is created based on an input from the first user through a mobile application installed in the first portable communication device. The connection is based on an invitation of the first user to at least the second user through the first portable communication device. The first set of data is received in real time. In addition, the one or more operations are performed based on the first set of data and the preview image of the first user. Also, the second set of data is collected in real time. The one or more operations are performed based on the first set of data and the preview image of the second user. The single image of at least two users is taken in real time based on the input of at least one user of the first user and the second user.

In an embodiment of the present disclosure, the first set of data includes camera quality, camera resolution, display size, screen size, operating system, RAM, ROM, types of sensors and accuracy of sensors.

In an embodiment of the present disclosure, the second set of data includes processed data associated with the body of the at least two users after performing the one or more operations on the preview image of the at least two users. The processed data includes cropped data and co-ordinates data of face, neck, chest, stomach, shoulder, hands and legs of the first user and the second user. The one or more operations include processing, simplifying, scaling, detecting, cropping, transforming, detecting, regenerating and filtering.

In an embodiment of the present disclosure, the method includes yet another step of requesting the at least second portable communication device associated with the second user located at the different geographical location. The request being sent to the second portable communication device associated with the second user for taking the single image with the first user in real time. Further, the request being sent by utilizing the unique code generated on the first portable communication device.

In an embodiment of the present disclosure, the method includes yet another step of customizing the single picture of the at least two users taken in real time. In addition, at least one of the at least two users customize the single image by adding one or more filters to the image in real time by rotating the image in left, right, top and bottom directions. Further, the one or more filters are in the form of video, gif, 3-D image, 2-D image, animation or combination of images and videos.

In an embodiment of the present disclosure, the method includes yet another step of analyzing the first set of data and the second set of data by using image processing techniques and one or more algorithms. The first set of data and the second set of data is analyzed to match co-ordinates of the single image of at least the two users with the co-ordinates of the display screen of the corresponding at least two portable communication devices.

In an embodiment of the present disclosure, the method includes yet another step of synchronizing one or more parameters to take the single picture of the at least two users located at the different geographical locations. In addition, the one or more parameters include camera features, image, the format of images, co-ordinates of image, lightning conditions and screen dimension.

In an embodiment of the present disclosure, the method includes yet another step of storing the first set of data associated with the portable communication device of the at least two portable communication devices. In addition, the method includes storing of the second set of data associated with the body of the at least two users. Further, the method includes storing of the single image of the at least two users. The storing is done in real time.

In an embodiment of the present disclosure, the method further includes sharing the single image of the at least two users located at the different geographical locations on real-time dynamic basis. In addition, the single image of the at least two users is shared on one or more web-based platforms or social-based platforms.

In a second example, a computer system is provided. The computer system may include one or more processors and a memory coupled to the one or more processors.

The memory may store instructions which, when executed by the one or more processors, may cause the one or more processors to perform a method. The method is configured for taking a real-time single image of at least two users located at any two different geographical locations. The method may include a first step of creating a channel to facilitate a connection between at least two portable communication devices. In addition, the method may include another step of generating a unique code on the first portable communication device to build the connection with at least the second portable communication device. Further, the method may include yet another step of receiving a first set of data associated with the first portable communication device. Furthermore, the method may include yet another step of triggering a camera associated with the first portable communication device system for rendering a real time preview of an image of the first user. The camera is triggered by a first signal generator circuitry embedded inside the first portable communication device. Moreover, the method may include yet another step of collecting a second set of data associated with body of the first user after performing one or more operations on the preview image of the first user. In addition, the method may include yet another step of receiving a first set of data associated with the second portable communication device after the connection of the at least two portable communication devices. Further, the method may include yet another step of triggering a camera associated with the second portable communication device for rendering a real time preview of an image of the second user. The camera of the second portable communication device is triggered by a second signal generator circuitry embedded inside the at least second portable communication device. Moreover, the method may include yet another step of collecting a second set of data associated with the body of the second user after performing one or more operations on the preview image of the second user. Furthermore, the method may include yet another step of taking the single image of the at least first user and the second user by synchronizing the hardware elements. The hardware elements are associated with the at least two portable communication devices. The first portable communication device is associated with the first user and the second portable communication device is associated with the second user. The channel is created based on an input from the first user through a mobile application installed in the first portable communication device. The connection is based on an invitation of the first user to at least the second user through the first portable communication device. The first set of data is received in real time. In addition, the one or more operations are performed based on the first set of data and the preview image of the first user. Also, the second set of data is collected in real time. The one or more operations are performed based on the first set of data and the preview image of the second user. The single image of at least two users is taken in real time based on the input of at least one user of the first user and the second user.

In a third example, a computer-readable storage medium is provided. The computer-readable storage medium encodes computer executable instructions that, when executed by at least one processor, performs a method. The method is configured for taking a real-time single image of at least two users located at any two different geographical locations. The method may include a first step of creating a channel to facilitate a connection between at least two portable communication devices. In addition, the method may include another step of generating a unique code on the first portable communication device to build the connection with at least the second portable communication device. Further, the method may include yet another step of receiving a first set of data associated with the first portable communication device. Furthermore, the method may include yet another step of triggering a camera associated with the first portable communication device system for rendering a real time preview of an image of the first user. The camera is triggered by a first signal generator circuitry embedded inside the first portable communication device. Moreover, the method may include yet another step of collecting a second set of data associated with body of the first user after performing one or more operations on the preview image of the first user. In addition, the method may include yet another step of receiving a first set of data associated with the second portable communication device after the connection of the at least two portable communication devices. Further, the method may include yet another step of triggering a camera associated with the second portable communication device for rendering a real time preview of an image of the second user. The camera of the second portable communication device is triggered by a second signal generator circuitry embedded inside the at least second portable communication device. Moreover, the method may include yet another step of collecting a second set of data associated with the body of the second user after performing one or more operations on the preview image of the second user. Furthermore, the method may include yet another step of taking the single image of the at least first user and the second user by synchronizing the hardware elements. The hardware elements are associated with the at least two portable communication devices. The first portable communication device is associated with the first user and the second portable communication device is associated with the second user. The channel is created based on an input from the first user through a mobile application installed in the first portable communication device. The connection is based on an invitation of the first user to at least the second user through the first portable communication device. The first set of data is received in real time. In addition, the one or more operations are performed based on the first set of data and the preview image of the first user. Also, the second set of data is collected in real time. The one or more operations are performed based on the first set of data and the preview image of the second user. The single image of at least two users is taken in real time based on the input of at least one user of the first user and the second user.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment for taking a real-time single image of at least two users located at different geographical locations, in accordance with various embodiments of the present disclosure;

FIG. 2A and FIG. 2B illustrate a flow chart for a method for taking the real-time single image of at least two users located at different geographical locations, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

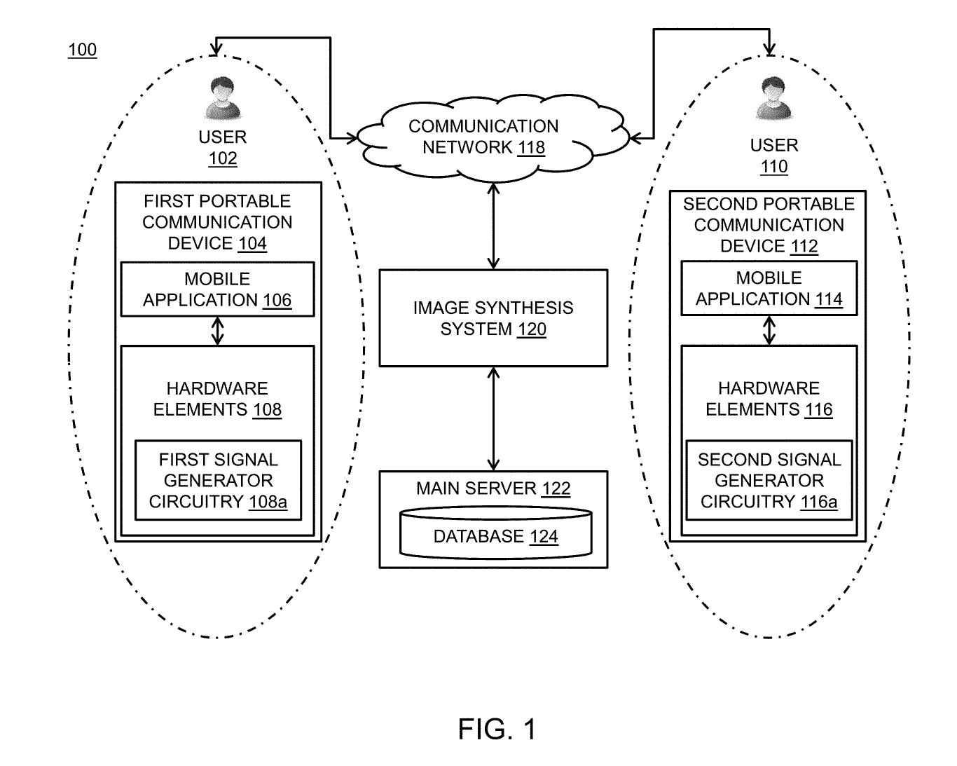

FIG. 1 illustrates a general overview of an interactive computing environment 100 for taking a single image of at least two users located at different locations, in accordance with various embodiments of the present disclosure. The interactive computing environment 100 allows the at least two users to take the image in a way that the at least two users appear to be located at a single geographical location. The interactive computing environment 100 includes a first portable communication device 104, a mobile application 106, first hardware elements 108 and a second portable communication device 112. In addition, the interactive computing environment 100 includes a mobile application 114, second hardware elements 116, a communication network 118, an image synthesis system 120, a main server 122 and a database 124.

The interactive computing environment 100 includes the first portable communication device 104. The first portable communication device 104 is associated with a first user 102. In general, the user can be any person or individual who wants to take a picture along with another user when both the users are at different geographical locations. In general, the portable communication device is any mobile device used for the communication purpose and entertainment purpose. Further, the first portable communication device 104 includes the first mobile application 106. The first mobile application 106 is installed on the first portable communication device 104. In general, the mobile application performs various tasks such as handling notifications and connectivity. Also, the mobile application is programmed in different languages for different platforms. Moreover, the use of the mobile application in online mode and offline mode depends on the type of application used. In an example, the mobile applications are used for entertaining, productivity, marketing purpose and the like. In an embodiment of the present disclosure, the first mobile application 106 is associated with the first hardware elements 108. The first hardware elements 108 include a first signal generator circuitry 108a. In addition, the first hardware elements 108 include but may not be limited to mic, camera, display, and sensor. The first hardware elements 108 are the main elements of the first portable communication device 104 that are synchronized with the first mobile application 106 on the real-time dynamic basis.

In an embodiment of the present disclosure, the interactive computing environment 100 includes the second portable communication device 112. The second portable communication device 112 is associated with a second user 110. The second user 110 is present at any different geographical location. The second user 110 has the second portable communication device 112. The second portable communication device 112 is any mobile device having a camera and network connectivity. Further, the second portable communication device 112 includes the second mobile application 114. The second mobile application 114 is installed on the second portable communication device 112. The second mobile application 114 performs various tasks such as handling notifications and connectivity. The second mobile application 114 is programmed in different languages for different platforms.

Further, the second mobile application 114 is associated with the second hardware elements 116. The second hardware elements 116 include a second signal generator circuitry 116a. In addition, the second hardware elements 116 include but may not be limited to mic, camera, display and sensor. The second hardware elements 116 are the main elements of the second portable communication device 112 that are synchronized with the second mobile application 114 on the real-time dynamic basis. Furthermore, the interactive computing environment 100 includes the communication network 118. The communication network 118 is responsible for connecting the first portable communication device 104 with the second portable communication device 112. Also, the communication network 118 is associated with the image synthesis system 120. The communication network 118 handles all the tasks related to the connectivity of the image synthesis system 120. The communication network 118 provides facilities such as compression for lesser connectivity zones for seamless connection between the at least two portable communication devices.

In an embodiment of the present disclosure, the image synthesis system 120 creates a channel to facilitate a connection between at least two portable communication devices. In an example, the at least two portable communication devices include the first portable communication device 104 and the second portable communication device 112. The first portable communication device 104 is associated with the first user 102 and the second portable communication device 112 is associated with the second user 110. In addition, the channel is created based on an input from the first user 102 through a mobile application 106. The mobile application 106 is installed in the first portable communication device 104. In an example, the channel is created when the first user 102 clicks on an initiating button in the mobile application 106 associated with the first portable communication device 104. In an embodiment of the present disclosure, the channel is created based on the input of the first user 102. In addition, the input of the first user 102 may be in the form of one or more steps followed by the user through the mobile application 106. Further, the one or more inputs may be in the form of text input, voice commands and motion gestures from the user.

In an embodiment, the image synthesis system 120 generates a unique code on the first portable communication device 104 to build the connection with the at least second portable communication device 112. In addition, the connection is based on an invitation of the first user 102 to the at least second user 110 through the first portable communication device 104. In an embodiment of the present disclosure, the unique code is generated on the first portable communication device 104 based on the request of the first user 102 for creating a connection with the at least second portable communication device 112. In an example, the unique code is generated on the first portable communication device 104 to build a secure connection with a specified user with whom the first user 104 wants to interact. In an example, the unique code generated on the first portable communication device 104 is a combination of alphabets, numbers and one or more special characters.

In an embodiment of the present disclosure, the image synthesis system 120 receives a first set of data associated with the first portable communication device 104. In an embodiment of the present disclosure, the first set of data includes information associated with the first portable communication device 104. In an example, the first set of data include but may not be limited to camera quality, camera resolution, display size, screen size, operating system, RAM, ROM, type of sensors and the accuracy of sensors. In another example, the first set of data includes the information of the first hardware elements 108 associated with the first portable communication device 104. In yet another example, the first set of data includes the working status of the first hardware elements 108 associated with the first portable communication device 104. The first hardware elements 108 include the first signal generator circuitry 108a. In addition, the first hardware elements 108 includes but may not be limited to mic, front camera, rear camera, display, speaker, audio jack, one or more integrated chip (IC), battery and SIM card. In another embodiment of the present disclosure, the first set of data includes hardware as well as software information of the first portable communication device 104.

In an embodiment of the present disclosure, the interactive computing environment 100 includes the first signal generator circuitry 108a embedded inside the first portable communication device 104. The first signal generator circuitry 108a generates a signal for triggering a camera associated with the first portable communication device 104 for rendering a real-time preview of an image of the first user 102. In addition, the camera is triggered when the signal generator circuitry 108a associated with the first portable communication device 104 generates a signal to trigger the camera of the first portable communication device 104. In an example, the front camera is triggered for rendering the real-time preview of the image of the first user 102. In another example, the rear camera is triggered for rendering the real-time preview of the image of the first user 102. In an embodiment of the present disclosure, the camera is triggered to show the appearance of the first user 102 when the first user 102 wants to click a picture with the at least second user 110 located at different location. In an embodiment of the present disclosure, the camera is triggered to collect the data associated with the preview image of the first user 102 in real time. In an example, the preview of the image of the first user 102 is rendered to the mobile application 106 on real-time dynamic basis.

The image synthesis system 120 collects a second set of data associated with the preview image of the first user 102 in real time. In an example, the image synthesis system 120 collects the data associated with the body of the first user 102 in real time after performing one or more operations on the preview image of the first user 102. In addition, the second set of data is the processed data associated with the body of the first user 102 after performing the one or more operations on the preview image of the first user 102. In an example, the processed data includes but may not be limited to cropped data or co-ordinates data of face, neck, chest, shoulder, hands, and legs of the first user 102. In an example, the one or more operations include but may not be limited to image processing, simplifying, transforming, regenerating, scaling, cropping and filtering. In another example, the one or more operations are the operations performed to collect required data from the stream data of the first user 102. The image synthesis system 120 detects the one or more parts of the body of the first user using one or more detecting techniques. In addition, the image synthesis system 120 detects the co-ordinates of the body parts associated with the real-time preview image of the first user 102. In an example, the image synthesis system 120 uses face detecting techniques and algorithms to detect the face of the first user 102. The image synthesis system 120 detects the face of the first user 102 to get the preview co-ordinates of the detected face. Further, the co-ordinates of the detected face are scaled and transformed to actual screen co-ordinates of the first portable communication device 104 based on the first set of data. In an example, the image synthesis system 120 analyzes and maps the co-ordinates of the detected face of the first user 102 with the co-ordinates of the screen of the first portable communication device 104. Further, the image synthesis system 120 stores the processed data obtained from the preview image of the first user 102 for further operations. The processed data is the second set of data extracted after performing one or more operations or one or more algorithms on the preview image of the first user 102. In an embodiment of the present disclosure, the second set of data is shared on to the connection component in real time using the communication network 118.

The image synthesis system 120 generates a request to the at least second portable communication device 112 associated with the second user 108 located at a different geographical place for taking the image with the first user 102 in real time. In an example, the image synthesis system 120 may generate the request to a plurality of users located at different geographical locations for taking the image with the first user 102. Each of the plurality of users is associated with one or more portable communication devices to take the image by using cameras of their portable communication devices. In general, the request to the at least second portable communication device 112 is generated based on the input of the first user 102 for the selection of the second user 110. In another embodiment of the present disclosure, the request may be sent to the plurality of users for taking the single image of the first user 102 with the plurality of users located at one or more different geographical places. Further, the request is sent to the at least second portable communication device 112 by utilizing the unique code generated on the first portable communication device 104. Furthermore, the request is sent for the mutual pairing of the first portable communication device 104 with the at least second portable communication device 112. Moreover, the request is sent to create a connection between the first portable communication device 104 and at least the second portable communication device 112 in real-time. Also, the request is sent through the mobile application 106 installed in the first portable communication device 104 to the at least second portable communication device 112 associated with the second user 110.

In an embodiment of the present disclosure, the image synthesis system 120 creates a connection between the first portable communication device 104 and the at least second portable communication device 112. In another embodiment of the present disclosure, the image synthesis system 120 creates the connection between the first portable communication device 104 and the plurality of portable communication devices. Further, the connection between the first portable communication device 104 and the at least second portable communication device 112 is created after the acceptance of the request by the second user 110. Furthermore, the request for the connection is accepted by the second user 110 through the mobile application 114 installed in the second portable communication device 112. Also, the connection between the first portable communication device 104 and the at least second portable communication device 112 is created in real time through the communication network 118. In another embodiment of the present disclosure, the second set of data is transferred to all the users connected to the first user 102 through the communication network 118.

In an embodiment of the present disclosure, the image synthesis system 120 is associated with the main server 122 through the communication network 118. In an embodiment, the communication network 118 enables the image synthesis system 120 to gain access to the internet for transmitting data to the main server 122 and the second portable communication device 112. Moreover, the communication network 118 provides a medium to transfer the first set of data and the second set of data between the image synthesis system 120 and the main server 122. Further, the medium for communication may be infrared, microwave, radio frequency (RF) and the like.

In an embodiment of the present disclosure, the image synthesis system 120 has the capability to work in average or below average network conditions such as 2G. In an example, the portable communication devices transmit the data through the communication network 118 using specially designed hardware run algorithms for poor network conditions. The image synthesis system 120 senses the poor network conditions and compresses the data on its own using the inbuilt hardware run algorithm. The same hardware run algorithm is applied to the other connected device in a situation of poor network conditions. The sensing of the poor network conditions and transmitting the data using compression techniques are done on the real-time dynamic basis. The communication network 118 is associated with the main server 122.

In an embodiment of the present disclosure, the image synthesis system 120 receives a first set of data associated with the second portable communication device 112. In addition, the first set of data includes the data associated with the second hardware elements 116. Further, the second hardware elements include the second signal generator circuitry 116a. The second signal generator circuitry 116a is embedded inside the second portable communication device 112. The second signal generator circuitry 116a generates a signal to trigger a camera associated with the second portable communication device 112 for rendering a real-time preview of the image of the second user 110. In addition, the camera is triggered to collect the data associated with the image of the second user 110. In an example, the camera is triggered to collect the data associated with the preview image of the second user 110. Moreover, the image synthesis system 120 collects a second set of data associated with the body of the second user 110 after performing the one or more operations on the image of the second user 110. The one or more operations are performed based on the first set of data associated with the second portable communication device 112 and the preview image of the second user 110. The second set of data is collected in real time.

In an embodiment of the present disclosure, the image synthesis system 120 analyzes the first set of data and the second set of data by using one or more image processing techniques and the one or more algorithms. In addition, the first set of data and the second set of data are analyzed to match co-ordinates of the image of the at least two users with co-ordinates of the display screen of the corresponding portable communication devices. In an example, the co-ordinates of the image of the first user 102 are matched with the co-ordinates of the screen based on the size of the screen of the first portable communication device 104. In another example, the co-ordinates of the image of the second user 110 are matched with the co-ordinates of the screen based on the size of the screen of the second portable communication device 112. In an embodiment of the present disclosure, the second set of data associated with the first user 102 is shared with the second set of data associated with the second user 110 in real time. In another embodiment of the present disclosure, the second set of data of the first user 102 is shared with the plurality of users on the corresponding portable communication devices to which the first user 102 is connected. The second set of data is shared to take a real-time single image of the first user 102 with the second user 110 when the second user 110 is located at a different geographical location than the first user 102. The first user 102 has the data of the face of the first user 102 and the second user 110. In addition, the second user 110 has the second set of data of the second user 110 and the first user 102.

In an embodiment of the present disclosure, the image synthesis system 120 takes the real-time single image of the first user 102 and the at least second user 110 located at different geographical locations. In addition, the real-time single image of the at least first user 102 and the second user 110 is taken by synchronizing hardware elements associated with the at least two portable communication devices. In an embodiment of the present disclosure, the real-time single image of at least two users is taken based on the input from the at least one user of the at least two users. In another embodiment of the present disclosure, the real-time single image is taken after a pre-defined time interval. The pre-defined time interval may be fixed by one user of the at least two users. In an example, the image synthesis system 120 takes the real-time single image of both the users in a live image format or gif format. In an embodiment, the image synthesis system 120 takes the real-time single of the first user 102 and the second user 110 based on the input of the first user 102. In another example, the image synthesis system 120 takes the real-time single image of the first user 102 and the second user 110 based on the input of the second user 110. In another embodiment of the present disclosure, the real-time single image may be taken by at least one of the plurality of users located at different geographical locations and connected together through communication network 118 in real time.

In an embodiment of the present disclosure, the image synthesis system 120 synchronizes the one or more parameters to take the single image of the at least two users located at different geographical locations. In addition, the one or more parameters include but may not be limited to format of the image, camera features, size of the image, co-ordinates of image, lightning conditions and screen dimension. In an embodiment of the present disclosure, the image synthesis system 120 is capable of synchronizing the camera of the first portable communication device 104 with the camera of the second portable communication device 112. In an example, the synchronization of the cameras of both the portable communication devices is done to take a single image of both the users in single file format on the real-time dynamic basis. In an example, the camera of the first portable communication device 104 might capture the image in png format. In addition, the camera of the second portable communication device 112 might capture the image in jpeg format. The image synthesis system 120 is capable of taking the single image of the at least two users located at different geographical locations in the single file format on the real-time dynamic basis.

In an embodiment of the present disclosure, the image synthesis system 120 synchronizes the camera of the at least two portable communication devices. In an example, the camera of the first portable communication device 104 and the second portable communication device 112 may have different resolutions. The image synthesis system 120 has to deal with the different resolutions of the cameras. In an example, a smartphone with a camera quality of around 16 megapixels. Another camera might be having a Carl Zeiss lens of resolution as high as 41 megapixels. The image synthesis system 120 synchronizes the different resolution cameras to take a single real-time image such that the image is of the highest resolution possible on the real-time dynamic basis. The one or more hardware run algorithms end up doing this task using specialized mechanism for taking the image to the best possible resolution.

In an embodiment of the present disclosure, the image synthesis system 120 is capable of synchronizing the images having different lighting conditions. In an example, a person in the USA wants to click an image in sunlight. Another person in India is using a low light camera smartphone and wants to click the image at night. The image synthesis system 120 is capable of taking a single picture of both the persons by adjusting the lighting condition of the two separate images on the real-time dynamic basis.

In another embodiment of the present disclosure, the image synthesis system 120 is capable of synchronizing screen dimensions and densities of the portable communication devices on the real-time dynamic basis. In an example, five users located at different geographical places want to take the single image in real time with each other. The dimension and density of the screen of portable communication devices of each user of the five users are different from each other. The image synthesis system 120 synchronizes the screen sizes based on the second set of data collected from different portable communication devices to take a real-time single image of the five users.

In yet another embodiment of the present disclosure, the cameras of the portable communication devices are working on the different operating system. In an example, a smartphone camera of Samsung Galaxy S7 has an Android operating system. The second smartphone camera of Apple iPhone 7 having an IOS operating system. Both the smartphones are different from each other on the basis of their operating system. The image synthesis system 120 is responsible to seamlessly integrate the hardware cameras of the different devices and take a single picture of at least two users located at different geographical locations on the real-time dynamic basis. In yet another embodiment of the present disclosure, the image synthesis system 120 is capable of taking a single image from different facing cameras on the different smartphones on the real-time dynamic basis. In an example, a person is taking a picture from the front camera of the smartphone A. Another person might be taking a picture from the back camera of the smartphone B. The front and back-facing cameras on the two different smartphones have different properties. The image synthesis system 120 takes a single image of both the persons such that the image appears to be taken at a single geographical location on real-time dynamic basis by synchronizing the facing of cameras.

In an embodiment of the present disclosure, the image synthesis system 120 customizes the single image of the at least two users based on the input from at least one of the at least two users. In addition, the customization is done by adding one or more filters to the single image in real time. Further, the customization is done by rotating the image in left, right, top and bottom directions. In an example, the one or more filters are in the form of video, gif, 3-D image, 2-D image, animation or a combination of image and video. In addition, the one or more filters may be in the form of 3-d model, 2-d model, AR-VR components. In an example, the user A wants to add a certain filter to enhance the beauty of the single image. The image synthesis system 120 gives the user A an option to add any filter of his choice in real time. The one or more filters added may be pre-defined in the mobile application used for clicking the single image. The one or more filters may also be added with the support of the third-party applications.

In another example, the image synthesis system 120 allows the users to apply different stickers and emoji on the taken single image on the real-time dynamic basis. In addition, the mobile applications have the inbuilt ability to apply special effects in the form of cartoon characters, emoji, and stickers to the single image in real time. Further, the image synthesis system 120 may also integrate with the third-party applications to further add one or more stickers to the single image in real time.

In an embodiment of the present disclosure, the one or more filters work on the basis of co-ordinates of the body parts of the users. In an example, the face co-ordinates give the users' left, right, top, bottom, rotation and mirror attributes for the particular filter. Further, the second set of data of the first user 102 and the second user 110 merged with the one or more filters selected by the users based on the face co-ordinates of the users. Also, the portable communication devices used for clicking the single image tweak these components according to the image size and the screen size. In an embodiment of the present disclosure, the real-time single image of the first user 102 and the second user 110 is translated and rotated based on the image taken by the at least two users. In an example, the image is rotated according to the view mode of the screen by using orientation specific sensors installed in the portable communication devices. In general, the one or more filters are used for the at least one user when each user has the data of other users.

In an embodiment of the present disclosure, the image synthesis system 120 displays the real-time single image of the at least two users in an augmented reality. The image appears to be present in the real world through the cameras of the at least one portable communication device. The image appears such as the image is present in front of the portable communication device. The image may be stored and shared to different platforms. In an example, at least two users want to click the single image on any festival, the image synthesis system 120 augments the clothes according to the festival on the body of the at least two users involved in clicking the image.

In another embodiment of the present disclosure, the image synthesis system 116 displays the captured image as a hologram on the real-time dynamic basis. In addition, the captured image may be converted into a three-dimensional image by using one or more image converting techniques.

In another embodiment of the present disclosure, the image synthesis system 120 is associated with a plurality of portable communication devices. In addition, the plurality of portable communication devices is associated with a plurality of users located at different geographical locations. The image synthesis system 120 allows the plurality of users to take a single picture with other users located at different geographical places on real-time dynamic basis. In an example, the image synthesis system 120 transfers the data of the first user 102 with other users in real time. Similarly, the image synthesis system 120 transfers the data of other users with first user 102 in real time. Thus, all the users have the data of faces of the other users as well as their own to take a single image with other users in real time. Furthermore, the image synthesis system 120 synchronizes the camera of the plurality of portable communication devices to take a single perfect image of the plurality of users located at different geographical locations. Also, the image synthesis system 120 allows the plurality of users to customize the single perfect image by using the one or more filters in real time.

In an embodiment of the present disclosure, the user may click a plurality of self-portrait pictures by using the corresponding portable communication device. The image synthesis system 120 allows the user to keep the desired image on the front portion and at least one of the plurality of self-portrait images on the background of the desired picture. In addition, the user may click plurality of images using front or rear camera of the portable communication device associated with the user. The image synthesis system 120 allows the user by giving one or more options to keep a suitable image of the plurality of images as a foreground image and other images as the background images. In an example, the user may define the number of images to be shown in background. In another example, the user may click continuous images in real time and the images will be automatically set as the background on real-time dynamic basis. In an example, the user A clicks four self-portrait pictures and finds one as a perfect picture. Thus, the image synthesis system 120 may allow the user A to set the rest three self-portrait pictures as a background of the perfect picture clicked by the user A in real time.

The image synthesis system 120 provides an option to share the real-time single image taken by the at least two users on the one or more web-based or social-based platforms. In an example, the user A and user B located at different geographical places click a single image using their portable communication devices. The image turns out to be perfect for sharing. Thus, the user A or the user B may share this image on the social-based platform. In an embodiment of the present disclosure, the image may be shared by using the same mobile application which was used by the at least two users for taking the real-time picture. In an example, the users may share this picture on any social media platform such as Facebook, WhatsApp and the like. In another example, the image synthesis system 120 allows the users to locally share the picture using data transfer applications such as Xender, Share.it and the like. The one or more images taken by the users are shared through the communication network 118. In addition, the communication network 118 is associated with the main server 122.

In an embodiment of the present disclosure, the main server 122 performs all the tasks related to the handling of the portable communication devices. The main server 122 receives the requests from the portable communication devices and processes these requests. In an example, the main server receives the request from the first portable communications device 104 and the second portable communication device 112. The main server 122 responds to the requests in an efficient manner. In an example, the main server 122 is present inside the image synthesis system 120. In another example, the main server 122 is remotely located. In addition, the main server 122 comprises the database 124. The database 124 is the storage location of all the data of the system. The database 124 contains the preview image data, the first set of data and the second set of data for the future reference and backup purposes. In an embodiment of the present disclosure, the image synthesis system 120 stores the image of the at least two users, the first set of data associated with the at least two portable communication devices in the database 124. In addition, the image synthesis system 120 stores the second set of data associated with the at least two users in the database 124. The image synthesis system 120 allows the users to retrieve the data from the database 124 by signing up for an account in case the user loses or delete images.

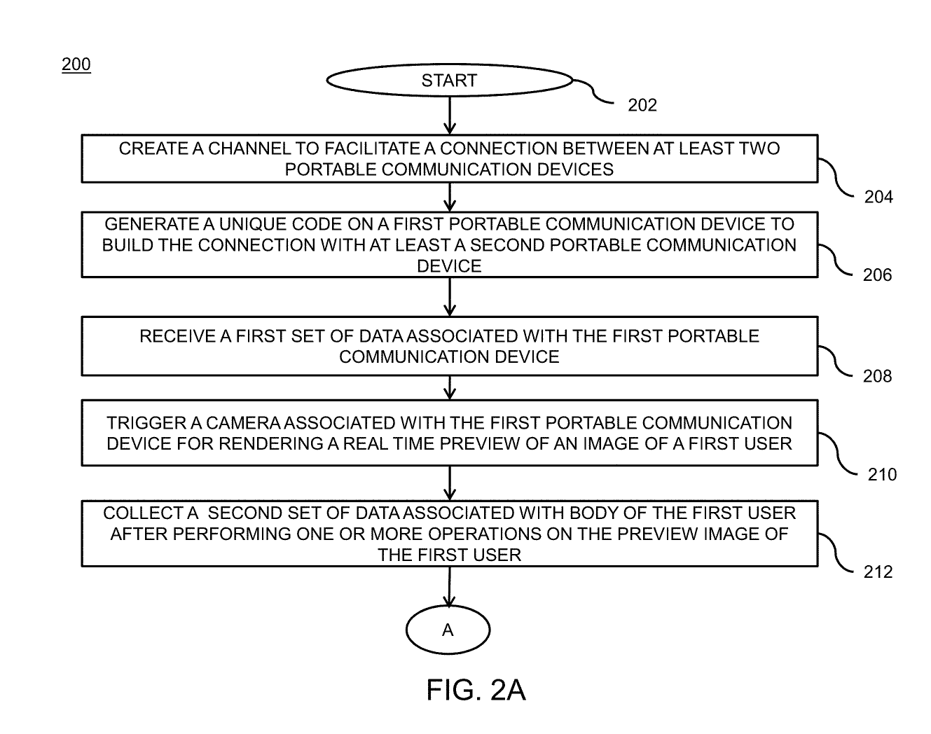

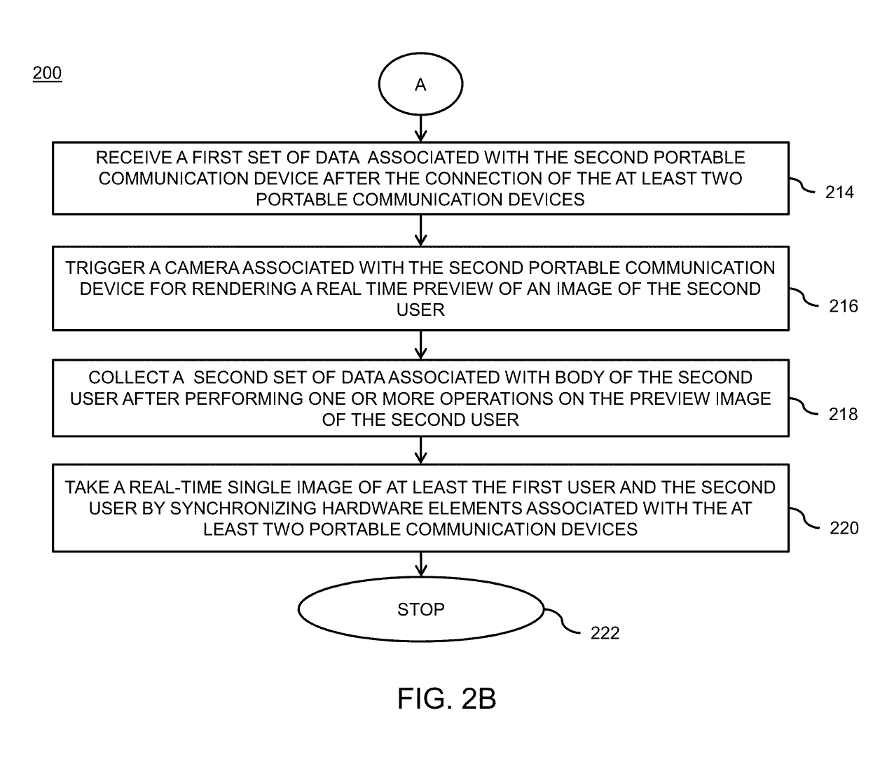

FIG. 2A and FIG. 2B illustrates a flow chart 200 of a method for taking the single image of the at least two users located at different locations, in accordance with various embodiments of the present disclosure. It may be noted that to explain the process steps of flowchart 200, references will be made to the system elements of FIG. 1. It may also be noted that the flowchart 200 may have lesser or more number of steps.

The flowchart 200 initiates at step 202. Following step 202, at step 204, the image synthesis system 120 creates the channel to facilitate the connection between the at least two portable communication devices. At step 206, the image synthesis system 120 generates the unique code on the first portable communication device 104 to build the connection with at least the second portable communication device 112. At step 208, the image synthesis system 120 receives the first set of data associated with the first portable communication device 104. At step 210, the image synthesis system 120 triggers the camera associated with the first portable communication device 104 for rendering the real time preview of the image of the first user 102. At step 212, the image synthesis system 120 collects the second set of data associated with the body of the first user 104 after performing the one or more operations on the preview image of the first user 102. At step 214, the image synthesis system 120 receives the first set of data associated with the second portable communication device 112 after the connection of the at least two portable communication devices. At step 216, the image synthesis system 120 triggers the camera associated with the second portable communication device 112 for rendering the real time preview of the image of the second user 110. At step 218, the image synthesis system 120 collects the second set of data associated with the body of the second user 110 after performing one or more operations on the preview image of the second user 110. At step 220, the image synthesis system 120 takes the real-time single image of at least the first user 102 and the second user 110 by synchronizing hardware elements associated with at least the two portable communication devices. The flow chart 200 terminates at step 222.

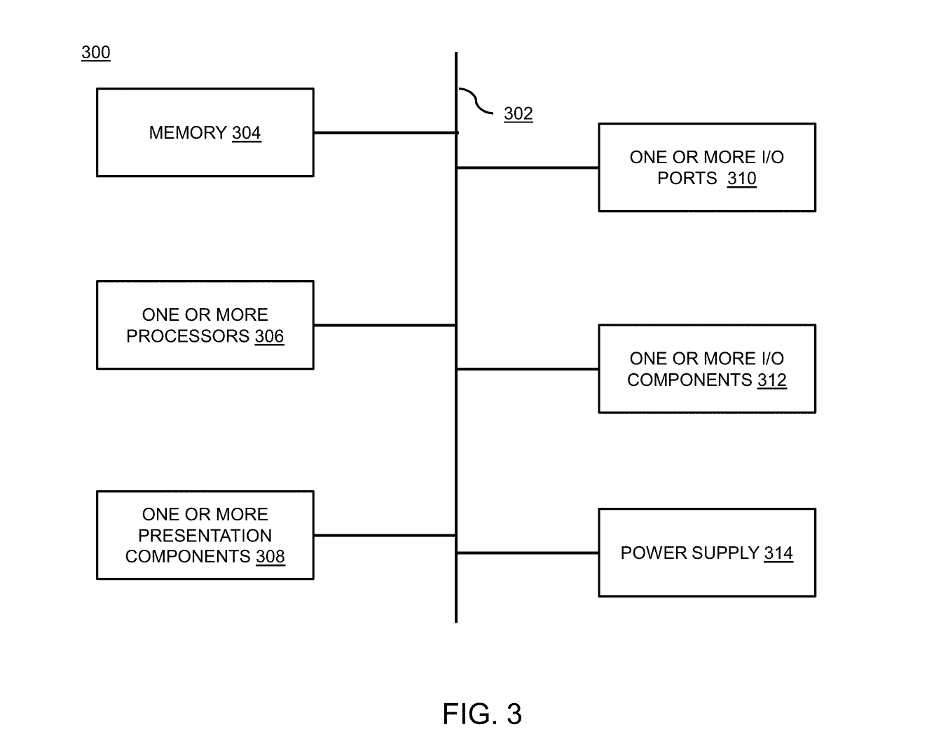

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 3 is merely illustrative of an exemplary computing device 300 may be used in connection with one or more embodiments of the present disclosure. Distinction is not made between such categories as workstation, server, laptop, hand-held device and the like, as all are contemplated within the scope of FIG. 3 and reference to “the computing device 300.”

The computing device 300 typically includes a computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 304 includes the computer-storage media in the form of volatile and/or nonvolatile memory. The memory 304 may be removable, non-removable, or a combination thereof. Exemplary hardware devices include solid-state memory, hard drives, optical-disc drives and the like. The computing device 300 includes the one or more processors to read data from various entities such as memory 304 or I/O components 312. The one or more presentation components 308 present data indications to a user or other device. Exemplary presentation components include a display device, speaker, printing component, vibrating component and the like. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for taking a real time single image of at least two users located at different geographical locations, the computer-implemented method comprising:
creating, at an image synthesis system with a processor, a channel to facilitate a connection between at least two portable communication devices, wherein a first portable communication device of the at least two portable communication device is associated with a first user and a second portable communication device of the at least two portable communication device is associated with a second user and wherein the channel is created based on an input from the first user through a mobile application installed in the first portable communication device;
generating, at the image synthesis system with the processor, a unique code on the first portable communication device to build the connection with at least the second portable communication device and wherein the connection is based on an invitation of the first user to at least the second user through the first portable communication device;
receiving, at the image synthesis system with the processor, a first set of data associated with the first portable communication device, wherein the first set of data is received in real time;
triggering, at the image synthesis system with the processor, a camera associated with the first portable communication device for rendering a real time preview of an image of the first user, wherein the camera is triggered by a first signal generator circuitry embedded inside the first portable communication device;
collecting, at the image synthesis system with the processor, a second set of data associated with body of the first user after performing one or more operations on the preview image of the first user, wherein the one or more operations is performed based on the first set of data and the preview image of the first user and wherein the second set of data is collected in real time;
receiving, at the image synthesis system with the processor, a first set of data associated with the second portable communication device after the connection of the at least two portable communication devices, wherein the first set of data is received in real time;
triggering, at the image synthesis system with the processor, a camera associated with the second portable communication device for rendering a real time preview of an image of the second user, wherein the camera of the second portable communication device is triggered by a second signal generator circuitry embedded inside the at least second portable communication device;
collecting, at the image synthesis system with the processor, a second set of data associated with body of the second user after performing one or more operations on the preview image of the second user, wherein the one or more operations is performed based on the first set of data associated with the second portable communication device and the preview image of the second user and wherein the second set of data is collected in real time; and
taking, at the image synthesis system with the processor, the real-time single image of at least the first user and the second user by synchronizing hardware elements associated with the at least two portable communication devices, wherein the real-time single image of both the users is taken based on the input of at least one user of the first user and the second user.

2. The computer-implemented method as claimed in claim 1, wherein the first set of data comprises camera quality, camera resolution, display size, screen size, operating system, RAM, ROM, types of sensors and accuracy of sensors.

3. The computer-implemented method as claimed in claim 1, wherein the second set of data comprises processed data associated with the body of the at least two users after performing the one or more operations on the preview image of the at least two users, wherein the processed data comprises cropped data and co-ordinates data of face, neck, chest, stomach, shoulder, hands and legs of the first user and the second user, wherein the one or more operations comprises processing, simplifying, scaling, transforming, detecting, cropping, regenerating and filtering.

4. The computer-implemented method as claimed in claim 1, further comprising requesting, at the image synthesis system with the processor, at least the second portable communication device associated with the second user for taking the single image with the first user in real time, wherein the first user and the second user are located at the different geographical locations and wherein the request is sent on the second portable communication device by utilizing the unique code generated on the first portable communication device.

5. The computer-implemented method as claimed in claim 1, further comprising customizing, at the image synthesis system with the processor, the single image of the at least two users taken in real time, wherein at least one of the at least two users customize the single image by adding one or more filters to the single image in real time by rotating the image in left, right, top and bottom directions and wherein the one or more filters is in form of video, gif, 3-d image, 2-d image, animation or a combination of images and videos.

6. The computer-implemented method as claimed in claim 1, further comprising analyzing, at the image synthesis system with the processor, the first set of data and the second set of data by using image processing techniques and one or more algorithms, wherein the first set of data and the second set of data are analyzed to match co-ordinates of the single image of at least the two users with co-ordinates of display screen of the corresponding portable communication devices.

7. The computer-implemented method as claimed in claim 1, further comprising synchronizing, at the image synthesis system with the processor, one or more parameters to take the single image of the at least two users located at the different geographical locations, wherein the one or more parameters comprises camera features, image, format of images, co-ordinates of image, lightning conditions and screen dimension.

8. The computer-implemented method as claimed in claim 1, further comprising storing, at the image synthesis system with the processor, the first set of data associated with the at least two users, the second set of data associated with the body of the at least two users and the single image of the at least two users, wherein the storing is done in real time.

9. The computer-implemented method as claimed in claim 1, further comprising sharing, at the image synthesis system with the processor, the single image of the at least two users located at different geographical locations on the real-time dynamic basis and wherein the single image is shared on one or more web-based platform and social based platform in real time.

10. A computer system comprising:
one or more processors; and
a memory coupled to the one or more processors, the memory for storing instructions which, when executed by the one or more processors, cause the one or more processors to perform a method for taking a real time single image of at least two users located at different geographical locations, the method comprising:
creating, at an image synthesis system, a channel to facilitate a connection between at least two portable communication devices, wherein a first portable communication device of the at least two portable communication device is associated with a first user and a second portable communication device of the at least two portable communication device is associated with a second user and wherein the channel is created based on an input from the first user through a mobile application installed in the first portable communication device;
generating, at the image synthesis system, a unique code on the first portable communication device to build the connection with at least the second portable communication device and wherein the connection is based on an invitation of the first user to at least the second user through the first portable communication device;
receiving, at the image synthesis system, a first set of data associated with the first portable communication device, wherein the first set of data is received in real time;
triggering, at the image synthesis system, a camera associated with the first portable communication device for rendering a real time preview of an image of the first user, wherein the camera is triggered by a first signal generator circuitry embedded inside the first portable communication device;
collecting, at the image synthesis system, a second set of data associated with body of the first user after performing one or more operations on the preview image of the first user, wherein the one or more operations is performed based on the first set of data and the preview image of the first user and wherein the second set of data is collected in real time;
receiving, at the image synthesis system, a first set of data associated with the second portable communication device after the connection of the at least two portable communication devices, wherein the first set of data is received in real time;
triggering, at the image synthesis system, a camera associated with the second portable communication device for rendering a real time preview of an image of the second user, wherein the camera of the second portable communication device is triggered by a second signal generator circuitry embedded inside the at least second portable communication device;
collecting, at the image synthesis system, a second set of data associated with body of the second user after performing one or more operations on the preview image of the second user, wherein the one or more operations is performed based on the first set of data associated with the second portable communication device and the preview image of the second user and wherein the second set of data is collected in real time; and
taking, at the image synthesis system, the real-time single image of at least the first user and the second user by synchronizing hardware elements associated with the at least two portable communication devices, wherein the real-time single image of both the users is taken based on the input of at least one user of the first user and the second user.

11. The computer system as claimed in claim 10, wherein the first set of data comprises camera quality, camera resolution, display size, screen size, operating system, RAM, ROM, types of sensors and accuracy of sensors.

12. The computer system as claimed in claim 10, wherein the second set of data comprises processed data associated with the body of the at least two users after performing the one or more operations on the preview image of the at least two users, wherein the processed data comprises cropped data and co-ordinates data of face, neck, chest, stomach, shoulder, hands and legs of the first user and the second user, wherein the one or more operations comprises processing, simplifying, scaling, transforming, detecting, cropping, regenerating and filtering.

13. The computer system as claimed in claim 10, further comprising requesting, at the image synthesis system, at least the second portable communication device associated with the second user for taking the single image with the first user in real time, wherein the first user and the second user are located at the different geographical locations and wherein the request is sent on the second portable communication device by utilizing the unique code generated on the first portable communication device.

14. The computer system as claimed in claim 10, further comprising customizing, at the image synthesis system, the single image of the at least two users taken in real time, wherein at least one of the at least two users customize the single image by adding one or more filters to the single image in real time by rotating the image in left, right, top and bottom directions and wherein the one or more filters is in form of video, gif, 3-d image, 2-d image, animation or a combination of images and videos.

15. The computer system as claimed in claim 10, further comprising analyzing, at the image synthesis system, the first set of data and the second set of data by using image processing techniques and one or more algorithms, wherein the first set of data and the second set of data are analyzed to match co-ordinates of the single image of at least the two users with co-ordinates of display screen of the corresponding portable communication devices.

16. The computer system as claimed in claim 10, further comprising synchronizing, at the image synthesis system, one or more parameters to take the single image of the at least two users located at the different geographical locations, wherein the one or more parameters comprises camera features, image, format of images, co-ordinates of image, lightning conditions and screen dimension.

17. The computer system as claimed in claim 10, further comprising storing, at the image synthesis system, the first set of data associated with the at least two users, the second set of data associated with the body of the at least two users and the single image of the at least two users, wherein the storing is done in real time.

18. The computer system as claimed in claim 10, further comprising sharing, at the image synthesis system, the single image of the at least two users located at different geographical locations on the real-time dynamic basis and wherein the single image is shared on one or more web-based platform and social based platform in real time.

19. A computer-readable storage medium encoding computer executable instructions that, when executed by at least one processor, performs a method for taking a real time single image of at least two users located at different geographical locations, the method comprising:
creating, at a computing device, a channel to facilitate a connection between at least two portable communication devices, wherein a first portable communication device of the at least two portable communication device is associated with a first user and a second portable communication device of the at least two portable communication device is associated with a second user and wherein the channel is created based on an input from the first user through a mobile application installed in the first portable communication device;
generating, at the computing device, a unique code on the first portable communication device to build the connection with at least the second portable communication device and wherein the connection is based on an invitation of the first user to at least the second user through the first portable communication device;
receiving, at the computing device, a first set of data associated with the first portable communication device, wherein the first set of data is received in real time;
triggering, at the computing device, a camera associated with the first portable communication device for rendering a real time preview of an image of the first user, wherein the camera is triggered by a first signal generator circuitry embedded inside the first portable communication device;
collecting, at the computing device, a second set of data associated with body of the first user after performing one or more operations on the preview image of the first user, wherein the one or more operations is performed based on the first set of data and the preview image of the first user and wherein the second set of data is collected in real time;
receiving, at the computing device, a first set of data associated with the second portable communication device after the connection of the at least two portable communication devices, wherein the first set of data is received in real time;
triggering, at the computing device, a camera associated with the second portable communication device for rendering a real time preview of an image of the second user, wherein the camera of the second portable communication device is triggered by a second signal generator circuitry embedded inside the at least second portable communication device;
collecting, at the computing device, a second set of data associated with body of the second user after performing one or more operations on the preview image of the second user, wherein the one or more operations is performed based on the first set of data associated with the second portable communication device and the preview image of the second user and wherein the second set of data is collected in real time; and
taking, at the computing device, the real-time single image of at least the first user and the second user by synchronizing hardware elements associated with the at least two portable communication devices, wherein the real-time single image of both the users is taken based on the input of at least one user of the first user and the second user.

20. The computer-readable storage medium as claimed in claim 19, further comprising customizing, at the computing device, the single image of the at least two users taken in real time, wherein at least one of the at least two users customize the single image by adding one or more filters to the single image in real time by rotating the image in left, right, top and bottom directions and wherein the one or more filters is in form of video, gif, 3-d image, 2-d image, animation or a combination of images and videos.
